(19) United States
(12) Patent Application Publication
(10) Pub. No.: US 2014/0055724 A1
(43) Pub. Date: Feb. 27, 2014

(54) DISPLAY PANEL AND DISPLAY APPARATUS HAVING THE SAME

(71) Applicant: Samsung Electronics Co., Ltd., Suwon-si (KR)

(72) Inventors: Seong-eun CHUNG, Seoul (KR); IL-YONG JUNG, Yongin-si (KR); Dong-hwan KIM, Seoul (KR); Tae-bae KIM, Hwaseong-si (KR); Dong-jun LEE, Cheonan-si (KR)

(73) Assignee: Samsung Electronics Co., Ltd., Suwon-si (KR)

(21) Appl. No.: 13/974,501

(22) Filed: Aug. 23, 2013

(30) Foreign Application Priority Data
Aug. 23, 2012 (KR) 10-2012-0092613

(51) Int. Cl. G02F 1/1335

(52) U.S. Cl. CPC G02F 1/133502
USPC 349/96

(57) ABSTRACT

Disclosed is a display panel of a display apparatus including the display panel and a backlight unit disposed under the display panel, the display panel including: an upper substrate; a lower substrate disposed to face the upper substrate in a traveling direction of light radiated from the backlight unit; a liquid crystal layer disposed between the upper substrate and the lower substrate; a polarizing layer disposed at least below the upper substrate and configured to transmit light polarized in a preset direction of the radiated light to the upper substrate; and an antireflection layer formed on a light exiting surface of the upper substrate through which the radiated light exits and configured to substantially prevent reflection of external light from an external environment thereon.

### CROSS-REFERENCE TO RELATED APPLICATION

This application claims priority from Korean Patent Application No. 10-2012-0092613, filed on Aug. 23, 2012, in the Korean Intellectual Property Office, the disclosure of which is incorporated herein in its entirety by reference.

### BACKGROUND

1. Field

Apparatuses and methods consistent with exemplary embodiments relate to a display panel displaying an image on a surface thereof and a display apparatus having the same, and more particularly, to a display panel displaying an image by light provided from a backlight unit and structured to substantially reduce interference in perception of the image displayed thereon due to reflected external light on a surface of the display panel and a display apparatus having the same.

2. Description of the Related Art

A display apparatus is a device which includes a display panel displaying images according to broadcast signals or various formats of image signals or image data and is configured as a television (TV), a monitor, or the like. The display panel is configured as various types such as, for example, a liquid crystal display (LCD) panel, a plasma display panel (PDP), or the like and is employed in a variety of display apparatuses. Here, when an LCD panel that does not generate light by itself is adopted as a display panel, a display apparatus includes a backlight unit to generate and provide light to the display panel.

When users perceive images displayed on the display apparatus with the foregoing configuration, perception of the images may be disturbed due to several factors. One of the factors is a glare phenomenon such that a surface of the display panel, on which images are displayed, is undesirably shining or bright due to reflection of external light from an external environment on the display panel. The glare phenomenon becomes serious when the external light has a greater quantity, and in severe cases, users may hardly see images displayed on the panel. To reduce the glare phenomenon, a dark external environment of the display panel is favorable. However, it is difficult to exclude the external light from the external environment in which the display panel is actually used. Therefore, a method or a structure for reducing a quantity of external light reflected on the surface of the display panel is needed for the display panel and the display apparatus including the same to improve perception of images displayed thereon.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an exemplary embodiment, there is provided a display panel of a display apparatus including the display panel and a backlight unit disposed under the display panel, the display panel including: an upper substrate; a lower substrate disposed to face the upper substrate in a traveling direction of light radiated from the backlight unit; a liquid crystal layer disposed between the upper substrate and the lower substrate; a polarizing layer disposed at least below the upper substrate and configured to transmit light polarized in a preset direction of the radiated light to the upper substrate; and an antireflection layer formed on a light exiting surface of the upper substrate through which the radiated light exits and configured to substantially prevent reflection of external light from an external environment thereon.

In the display panel, the antireflection layer may include a nanoscale embossed pattern distributed on the light exiting surface of the upper substrate.

In the display panel, the antireflection layer may be formed directly on the light exiting surface of the upper substrate.

In the display panel, the pattern may have a cross section in at least one from among substantially rectangular, substantially parabolic and substantially dome shapes.

In the display panel, the antireflection layer may include a pattern formed of at least one from among silicone, ultraviolet (UV)-curable silicone, and a photoresist.

In the display panel, the antireflection layer may be formed by forming the pattern on a coating layer of the UV-curable silicone, the pattern being obtained by pressing a polyvinyl alcohol (PVA) film formed corresponding to the pattern against the coating layer of UV-curable silicone formed on the upper substrate, curing the coating layer, and removing the PVA film.

In the display panel, the coating layer may be cured by UV irradiation.

In the display panel, the PVA film may be removed by washing the PVA film with water.

In the display panel, the antireflection layer may be formed by stacking a PVA film formed with the pattern of the photoresist on the upper substrate, forming the pattern on the upper substrate by using at least one from among heat and pressure, and removing the PVA film.

In the display panel, the antireflection layer may be formed by stacking the pattern of the photoresist on a coating layer of the silicone on the upper substrate, corroding the coating layer by an etching process, and removing the photoresist.

In the display panel, the etching process may include dry etching using at least one from among oxygen and argon gas.

In the display panel, the antireflection layer may be formed by stacking the pattern of the photoresist on the upper substrate, corroding the upper substrate by an etching process, and removing the photoresist.

In the display panel, the polarizing layer may be disposed at least one from among between the upper substrate and the liquid crystal layer, between an light exiting surface of the lower substrate and the liquid crystal layer, and under a light entering surface of the lower substrate.

According to an aspect of another exemplary embodiment, there is provided a display apparatus including: a signal reception unit configured to receive an image signal from an outside; a signal processing unit configured to process the image signal received by the signal reception unit according to a preset image processing process; and a display panel configured to display an image based on the image signal processed by the signal processing unit and according to one of the above described configurations.

### BRIEF DESCRIPTION OF THE DRAWINGS

The above and/or other aspects will become more apparent by describing certain exemplary embodiments, taken in conjunction with the accompanying drawings, in which:

FIG. 1 illustrates a display apparatus according to an exemplary embodiment;

FIG. 2 is an exploded perspective view of the display apparatus of FIG. 1;

FIG. 3 is a cross-sectional view illustrating a structure in which elements of a display panel are stacked in the display apparatus of FIG. 1;

FIG. 4 is a schematic cross-sectional view illustrating a main part of an antireflection layer of the display panel of FIG. 3;

FIGS. 5 and 6 schematically illustrate a process of manufacturing the antireflection layer of FIG. 4;

FIGS. 7 and 8 schematically illustrate a process of manufacturing an antireflection layer according to another exemplary embodiment;

FIGS. 9 and 10 schematically illustrate a process of manufacturing an antireflection layer according to still another exemplary embodiment;

FIG. 11 schematically illustrates a process of manufacturing an antireflection layer according to still another exemplary embodiment; and

FIG. 12 is a block diagram illustrating a configuration of a display apparatus according to an exemplary embodiment.

### DETAILED DESCRIPTION

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

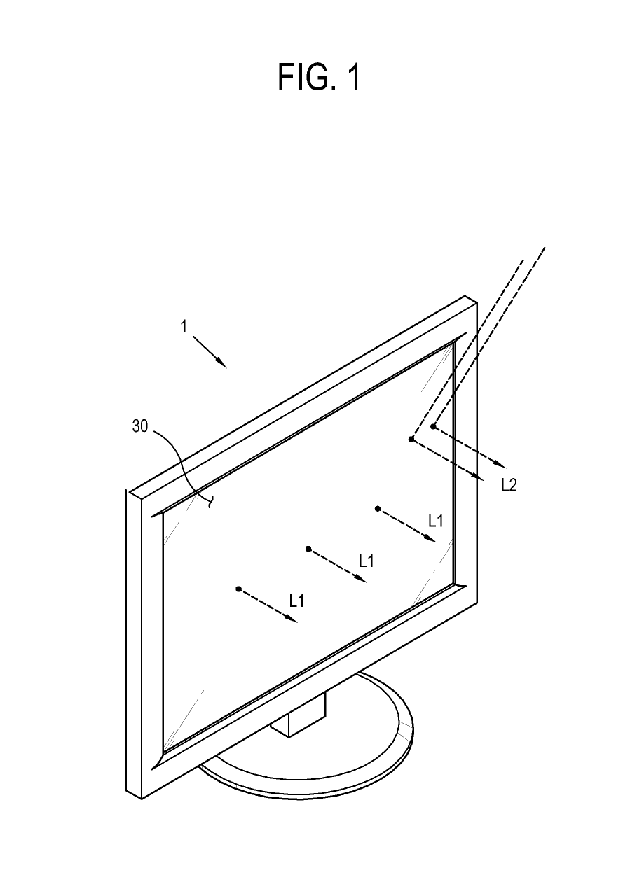

FIG. 1 illustrates a display apparatus 1 according to an exemplary embodiment.

The display apparatus 1 as shown in FIG. 1 is a device which is capable of processing an image signal from an external source and displaying an image based on the processed image signal. FIG. 1 illustrates a television (TV) as the display apparatus 1. However, the display apparatus 1 is not limited to a particular kind but may include any structure having a display panel 30 that displays an image, for example, a TV, a monitor, a portable multimedia player, a mobile phone, or the like.

The display panel 30 generates light for displaying an image or is provided with light from a separate element. An organic light emitting diode (OLED) panel as the display panel 30 generates light by itself to display an image. On the other hand, a liquid crystal display (LCD) panel as the display panel 30 does not generate light by itself but is provided with light generated by a backlight unit (not shown).

The display panel 30 allows light L1 to be emitted from an entire panel surface to an outside so that a user may perceive an image displayed on a panel surface.

However, in an environment where the display apparatus 1 is used, while the image is being displayed on the display panel 30, external light L2 reaches a surface of the display panel 30 on which the image is displayed. When the external light L2 is not absorbed or passes through the surface of the display panel 30, the external light L2 is reflected on the display panel 30. Therefore, it may be difficult for the user to perceive the image displayed on the display panel 30 due to the reflected external light L2.

Accordingly, exemplary embodiments introduce a structure for substantially preventing reflection of the external light L2 on the display panel 30, thereby assisting the user to clearly and readily perceive the image displayed on the display panel 30, which will be described in detail.

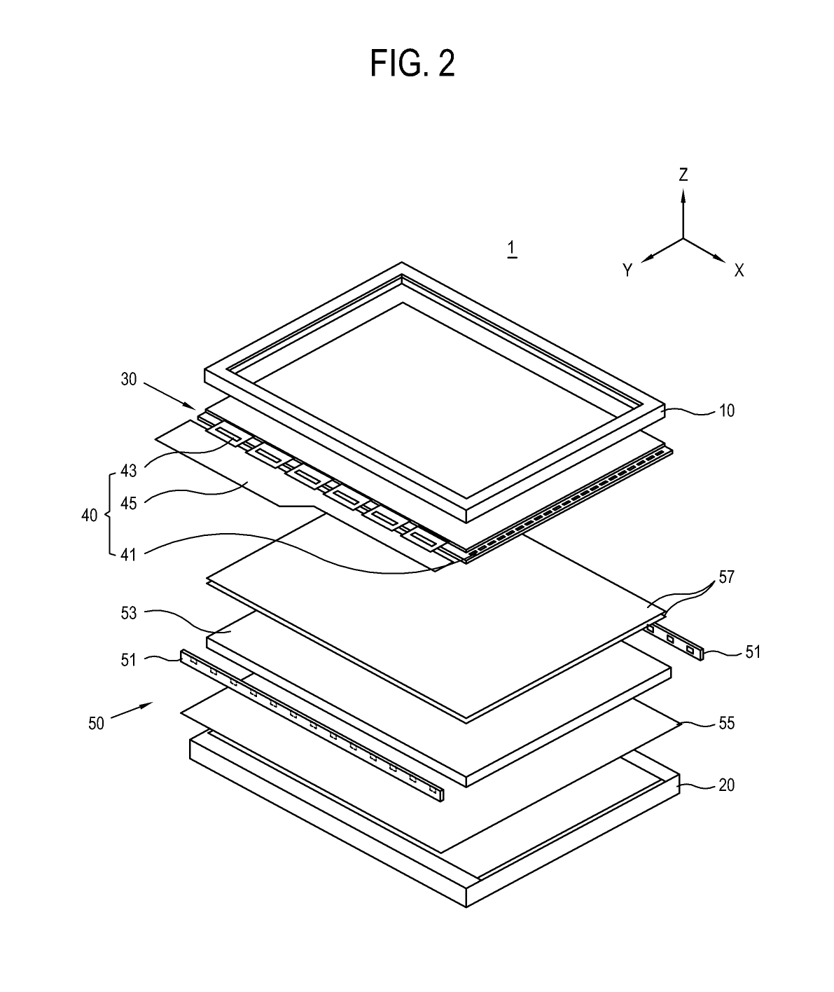

Hereinafter, a configuration of the display apparatus 1 will be described with reference to FIG. 2.

FIG. 2 is an exploded perspective view of the display apparatus 1. The present embodiment illustrates the display apparatus 1 including an LCD panel as the display panel 30.

As shown in FIG. 2, the display apparatus 1 includes covers 10 and 20 forming an interior space, the display panel 30 accommodated in the interior space formed by the covers 10 and 20 and displaying images on a surface thereof, a panel driving unit 40 driving the display panel 30, and a backlight unit 50 accommodated in the interior space formed by the covers 10 and 20 to face a lower surface of the display panel 30 and providing light to the display panel 30.

First, directions shown in FIG. 2 are defined as follows. Basically, X, Y, and Z directions of FIG. 2 indicate width, length, and height directions of the display panel 30, respectively. The display panel 30 is disposed on an X-Y plane, and the covers 10 and 20, the display panel 30 and the backlight unit 50 are arranged along a Z-axis. Here, opposite X, Y, and Z directions are expressed as −X, −Y, and −Z directions, respectively, and the X-Y plane means a plane defined by an X-axis and a Y-axis.

Unless specifically defined, the terms “upper” and “above” refer to a higher location in the Z-direction, while the terms “lower” and “under” refer to a lower location in the −Z direction. For example, the backlight unit 50 is disposed under the display panel 30, and light radiated from the backlight unit 50 enters the lower surface of the display panel 30 and exits through an upper surface of the display panel 30.

The covers 10 and 20 form an outward shape of the display apparatus 1 and support the display panel 30 and the backlight unit 40 which are accommodated therein. Defining the Z direction as a front direction toward a front side of the display panel 30 and the −Z direction as a rear direction toward a rear side of the display panel 30 in FIG. 2, the covers 10 and 20 include a front cover 10 supporting a front side of the display panel 30 and a rear cover 20 supporting a rear side of the backlight unit 50. The front cover 10 has an opening formed on an upper surface thereof substantially parallel with the X-Y plane to expose an image display area of the display panel 30 therethrough.

The display panel 30 is configured as an LCD panel. The display panel 30 is formed of two substrates (not shown) and a liquid crystal layer (not shown) interposed therebetween and displays images on a surface thereof by adjusting an arrangement of liquid crystals in the liquid crystal layer (not shown) through driving signals applied thereto. The display panel 30 does not emit light by itself and thus is provided with light from the backlight unit 50 to display images in the image display area thereof.

The panel driving unit 40 applies a driving signal for driving the liquid crystal layer to the display panel 30. The panel driving unit 40 includes a gate drive integrated circuit (IC) 41, a data chip film package 43, and a printed circuit board (PCB) 45.

The gate drive IC 41 is integrally formed on a substrate (not shown) of the display panel 30 and is connected to each gate line (not shown) on the display panel 30. The data chip film package 43 is connected to each data line (not shown) formed on the display panel 30. Here, the data chip film package 43 may include a wiring pattern, obtained by forming semiconductor chips on a base film thereof, and a tape automated bonding (TAB) tape bonded by a TAB technique. The data chip film package 43 may include, for example, a tape carrier package (TCP) or a chip on film (COF). Meanwhile, the PCB 45 inputs a gate drive signal to the gate drive IC 41 and inputs a data drive signal to the data chip film package 43.

With this configuration, the panel driving unit 40 inputs drive signals to each gate line (not shown) and each data line (not shown) on the display panel 30, respectively, to drive the liquid crystal layer (not shown) in a unit of a pixel.

The backlight unit 50 may be disposed under the display panel 30, that is, in the −Z direction of the display panel 30, to provide light to the lower surface of the display panel 30. The backlight unit 50 includes a light source unit 51 disposed on an edge of the display panel 30, a light guide plate 53 disposed substantially parallel with the display panel 30 to face the lower surface of the display panel 30, a reflection plate 55 disposed under the light guide plate 53 to face a lower surface of the light guide plate 53, and at least one optical sheet 57 disposed between the display panel 30 and the light guide plate 53.

The present embodiment illustrates an edge-type backlight unit 50 in which the light source unit 51 is disposed on an edge of the light guide plate 53 and a light emitting direction of the light source unit 51 and a light exiting direction of the light guide plate 53 are substantially perpendicular to each other. However, a structure of the backlight unit 50 may be variously changed or modified in design, without being limited to the present embodiment. For example, a direct-type backlight unit 50 may be used in which the light source unit 51 is disposed under the light guide plate 53 and the light emitting direction of the light source unit 51 and the light exiting direction of the light guide plate 53 are substantially parallel with each other.

The light source unit 51 generates light and radiates the generated light to enter the light guide plate 53. The light source unit 51 is installed substantially perpendicular to the surface of the display panel 30, that is, the X-Y plane, and disposed along at least one of four edges of the display panel 30 or the light guide plate 53. The light source unit 51 includes light emitting elements (not shown), configured as, for example, light emitting diodes (LEDs), sequentially disposed on a module substrate (not shown) in the X direction.

The light guide plate 53, which includes a plastic lens formed of acrylic materials, substantially uniformly transmits light incident from the light source unit 51 to the entire image display area of the display panel 30. A lower side of the light guide plate 53 in the −Z direction faces the reflection plate 55. Further, among four side walls formed between an upper side and the lower side in four directions of the light guide plate 53, side walls in the X and −X directions face the light source unit 51. Light radiated from the light source unit 51 enters the side walls in the X and −X directions.

The light guide plate 53 includes various optical patterns (not shown) formed on the lower side thereof to diffuse and/or reflect light proceeding in the light guide plate 53 or change a traveling direction of the light, thereby substantially uniformly distributing light exiting from the light guide plate 53.

The reflection plate 55 under the light guide plate 53 reflects light exiting from an inside of the light guide plate 53 toward the outside, thus directing the light back toward the light guide plate 53. The reflection plate 55 reflects light not reflected by the optical patterns (not shown) formed on the lower side of the light guide plate 53 back into the light guide plate 53. To this end, an upper surface of the reflection plate 55 has total reflection characteristics.

The at least one optical sheet 57 is stacked on the light guide plate 53 to adjust characteristics of light exiting from the light guide plate 53. The at least one optical sheet 57 may include a diffusion sheet, a prism sheet, a protection sheet and a dual brightness enhancement film (DBEF), among which two or more sheets may be stacked in combination to obtain desired light characteristics.

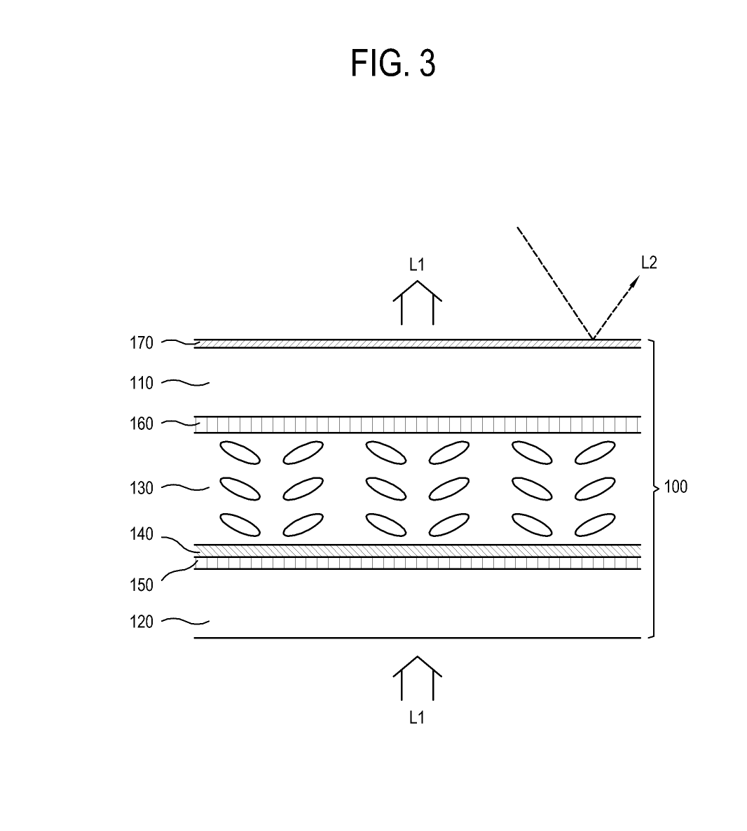

Hereinafter, a configuration of a display panel 100 according to an exemplary embodiment will be described in detail with reference to FIG. 3. It should be noted that the configuration of the display panel 100 to be described below is provided for illustrative purpose only and is not construed as limiting the scope of the present embodiment.

FIG. 3 is a cross-sectional view illustrating that elements of the display panel 100 are stacked. The display panel 100 of FIG. 3 has a configuration substantially the same as the display panel 30 shown in FIGS. 1 and 2 and thus may be also applied to the display apparatus 1 of FIG. 1.

As shown in FIG. 3, light L1 radiated in the Z direction from the backlight unit 50 (see FIG. 2) enters the display panel 100 and exits in the Z direction via various elements of the display panel 100. In the following description, spatially relative terms, such as “upper,” “above,” “lower” and “under” may be used herein for ease of description to describe the relationship of one element or feature to another element(s) or feature(s) in arrangement or deposition based on the Z direction in which the light L1 proceeds.

The display panel 100 includes an upper substrate 110, a lower substrate 120 disposed to face the upper substrate 110, a liquid crystal layer 130 disposed between the upper substrate 110 and the lower substrate 120, a color filter layer 140 disposed between the liquid crystal layer 130 and the lower substrate 120, a lower polarizing layer 150 disposed on an upper side of the lower substrate 120, an upper polarizing layer 160 disposed on a lower side of the upper substrate 110, and an antireflection layer 170 formed on an upper surface of the upper substrate 110. In addition, the display panel 100 may further include a protection film (not shown) covering an upper side of the antireflection layer 170 or a lower side of the lower substrate 120 so as to protect the foregoing elements.

Hereinafter, elements of the display panel 100 will be described in detail.

The upper substrate 110 and the lower substrate 120 are transparent substrates disposed at a predetermined interval in the light proceeding direction to face each other. The upper substrate 110 and the lower substrate 120 may be formed of a glass or plastic substrate. As a plastic substrate, the upper substrate 110 and the lower substrate 120 may include polycarbonate, polyimide (PI), polyethersulphone (PES), polyacrylate (PAR), polyethylenenaphthelate (PEN), or polyethyleneterephehalate (PET).

The upper substrate 110 and the lower substrate 120 have different characteristics based on a drive method of the liquid crystal layer 130. For example, in a passive-matrix liquid crystal layer 130, the upper substrate 110 and the lower substrate 120 may include soda lime glass. In an active-matrix liquid crystal layer 130, the upper substrate 110 and the lower substrate 120 may include alkali free glass or borosilicate glass.

The liquid crystal layer 130 is disposed between the upper substrate 110 and the lower substrate 120 and adjusts light transmittance thereof according to a change in arrangement of the liquid crystals based on an applied driving signal. A liquid generally includes molecules with irregular orientation and arrangement, while liquid crystals are in a state with regularity to a certain extent and a phase similar to a liquid phase. For example, there is a solid which becomes in a liquid phase exhibiting anisotropic properties such as birefringence when heated and melted. Liquid crystals have optical properties such as birefringence or color change. A liquid crystal is called such a name since the liquid crystal has properties of both liquid and solid crystal, for example, regularity as a crystal-like property and a liquid-like phase. When voltage is applied to the liquid crystals, an arrangement of the molecules is changed and optical properties of the liquid crystals are also changed accordingly.

The liquid crystals in the liquid crystal layer 130 may be classified into nematic, cholesteric, smectice, and ferroelectric liquid crystals based on an arrangement of the molecules.

The color filter layer 140 is disposed between the liquid crystal layer 130 and the lower substrate 120, and filters incident light so that a predetermined color of light is emitted with respect to each pixel of the liquid crystal layer 130.

The color filter layer 140 converts light entering the display panel 100 into red, green, and blue (RGB) colors to be transmitted to the liquid crystal layer 130. A pixel of the liquid crystal layer 130 includes sub-pixels corresponding to the RGB colors, respectively, and the color filter layer 140 conducts filtering by color with respect to each sub-pixel. Accordingly, when light passes through each sub-pixel, light of different colors by sub-pixels is emitted by the color filter layer 140. In the present embodiment, the color filter layer 140 is disposed closer to the lower substrate 120, without being limited thereto. Alternatively, the color filter layer 140 may be disposed closer to the upper substrate 110.

The lower polarizing layer 150 is disposed between the lower substrate 120 and the color filter layer 140, and the upper polarizing layer 160 is formed between the upper substrate 110 and the liquid crystal layer 130. The lower polarizing layer 150 and the upper polarizing layer 160 are provided to transmit light polarized in a preset direction of incident light. The lower polarizing layer 150 and the upper polarizing layer 160 may transmit light polarized in the same direction or different directions depending on a design.

The present embodiment illustrates that the upper polarizing layer 160 and the lower polarizing layer 150 are formed respectively on the upper substrate 110 and the lower substrate 120, which are above and below the liquid crystal layer 130. However, in an alternative embodiment, one of the lower polarizing layer 150 and the upper polarizing layer 160 may be formed depending on a design of the display panel 100. Also, in an alternative embodiment, the polarizing layers 150 and 160 may be disposed under the lower substrate 120, instead of between the upper substrate 110 and the lower substrate 120. Here, in the present embodiment, the polarizing layers 150 and 160 are not disposed or formed on an upper side of the upper substrate 110.

The antireflection layer 170 is formed on an upper surface of the upper substrate 110 as a top layer of the display panel 100, thereby substantially preventing external light L2 by an external environment from being reflected on the surface of the display panel 100.

According to a related art, an antiglare film or an antireflection film is stacked on a top of a display panel to prevent reflection of the external light L2 on the surface of the display panel. The display panel according to the related art has a structure in which the polarizing layers 150 and 160 are stacked on the upper side of the upper substrate 110, unlike the configuration of the display panel 100 according to the present embodiment shown in FIG. 3. Thus, in the related art, the antiglare film or the antireflection film is not directly stacked or formed on the upper substrate 110 but is stacked on the polarizing layers 150 and 160.

The antiglare film has such a structure that the external light L2 is reflected in a random direction on a surface thereof to scatter the external light L2, thereby substantially suppressing transmission of light reflected on the display panel 100 to eyes of a user. The antiglare film has a specular reflectance of about 2.0% to about 2.5% and is applied to a large-screen display panel.

Meanwhile, the antireflection film is formed by depositing a plurality of materials having different refractive indices in a multilayer structure, thereby substantially preventing reflection of the external light L2 on a surface between respective coating layers by using a change in refractive index. As such, the antireflection film substantially prevents the external light L2, showing an excellent specular reflectance of about 0.1% to about 1.0%. However, it is not easy to apply the antireflection film to a large-screen display panel due to lower cost efficiency and difficulties in manufacturing.

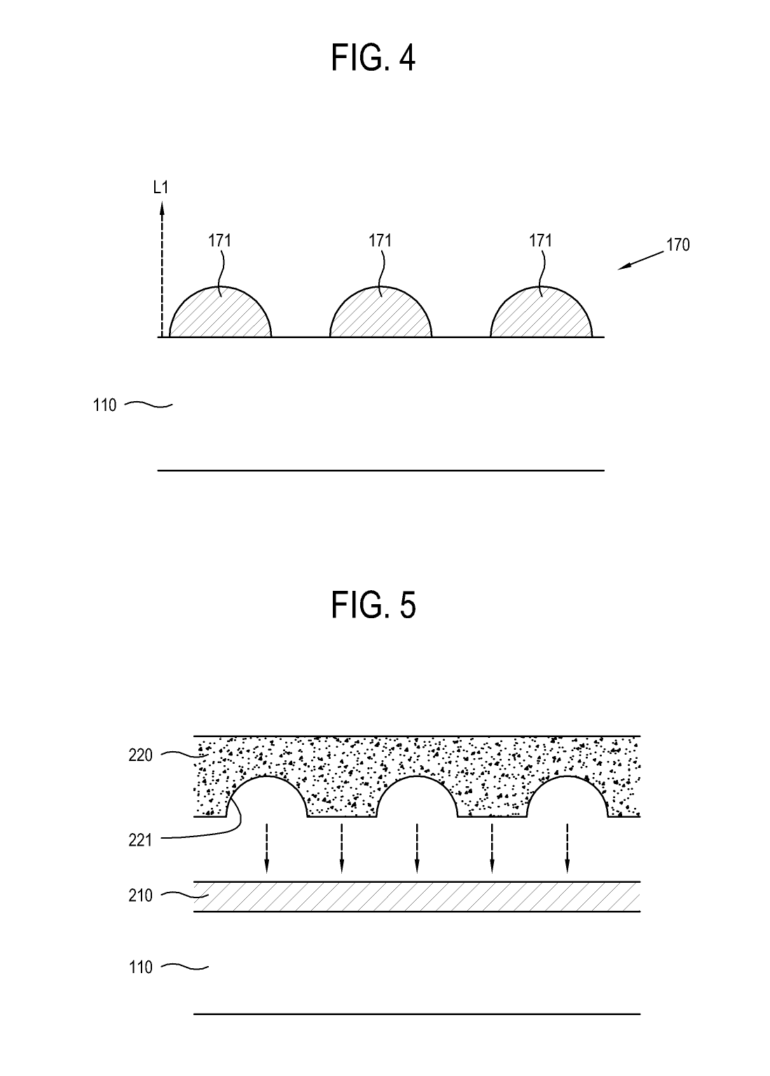

Thus, the display panel 100 according to the present embodiment adopts the antireflection layer 170 with a structure illustrated in FIG. 4.

FIG. 4 is a schematic cross-sectional view illustrating a main part of the antireflection layer 170 according to an exemplary embodiment.

As shown in FIG. 4, the antireflection layer 170 includes embossed patterns 171 distributed and formed on a surface of the upper substrate 110, particularly an upper surface from which radiated light L1 exits. The patterns 171 are a nanoscale structure of dozens to hundreds of nanometers, which have a cross section in a rectangular, parabolic or dome shape.

The patterns 171 include silicone, ultraviolet (UV)-curable silicone or photoresist.

The patterns 171 may be distributed in substantially the same shape and the same size or in varying shapes and varying sizes depending on a design. Further, the patterns 171 may be distributed at regular intervals or irregular intervals.

The antireflection layer 170 may have improved properties of substantially preventing reflected light with a specular reflectance of about 1% or less. Also, the antireflection layer 170 is easier to manufacture, as compared with an antireflection film, and thus may be applied to a large-screen display panel 100.

In addition, the antireflection layer 170 of the present embodiment is formed directly on the upper substrate 110 and thus may be easily applied to a structure in which a separate layer, such as the polarizing layer 150 or 160, is not stacked on the upper side of the upper substrate 110.

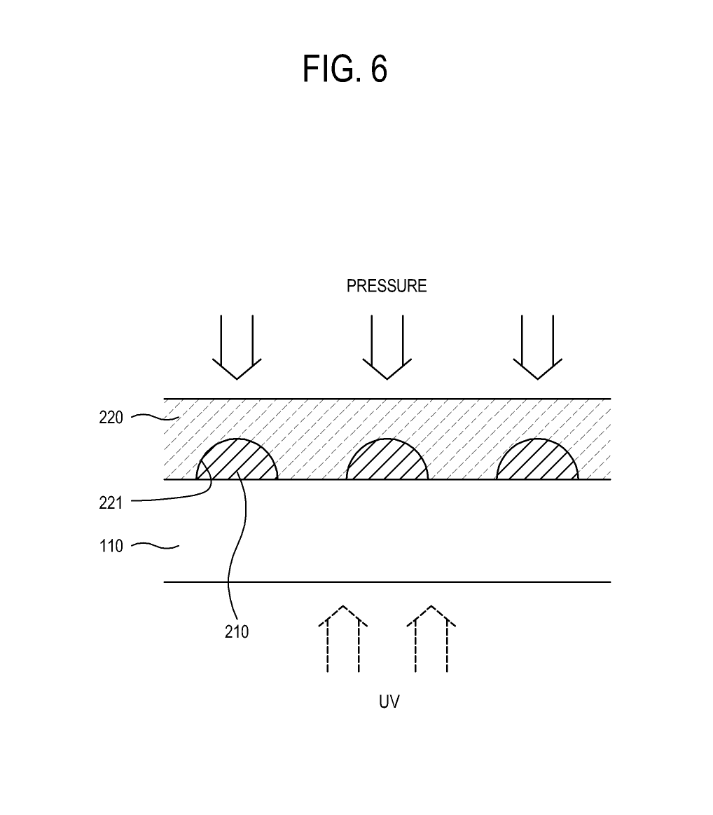

Hereinafter, a method of forming the antireflection layer 170 on the upper substrate 110 according to an exemplary embodiment will be described with reference to FIGS. 5 and 6.

FIGS. 5 and 6 schematically illustrate a process of manufacturing the antireflection layer 170.

As shown in FIG. 5, an ultraviolet (UV)-curable silicone layer 210 is applied to the upper substrate 110. UV-curable silicone is a mixture of silicone with various substances cured by UV. The UV-curable silicone coating layer 210 is in a flexible semi-cured state when applied to the upper substrate 110.

In this state, a polyvinyl alcohol (PVA) film 220 engraved with a pattern 221 as shown in FIG. 4 is stacked on the coating layer 210. PVC is prepared by hydrolysis of polyvinyl acetate to remove acetate groups. The PVC includes a hydroxyl group and thus is water-soluble.

As shown in FIG. 6, when pressure is applied to the PVA film 220 stacked on the coating layer 210, a pattern is formed on the coating layer 210 in accordance with the engraved pattern 221 of the PVA film 220.

Then, UV is irradiated from below the upper substrate 110, thereby curing the coating layer 210 with the pattern 221.

When the coating layer 210 is substantially completely cured, the PVA film 220 is washed with water to remove the water-soluble PVA film 220 from the upper substrate 110 and the coating layer 210. As a result, the antireflection layer 170 is formed on the upper substrate 110 by the pattern 221 of the coating layer 210.

According to this process, the display panel 100 including the antireflection layer 170 may be manufactured.

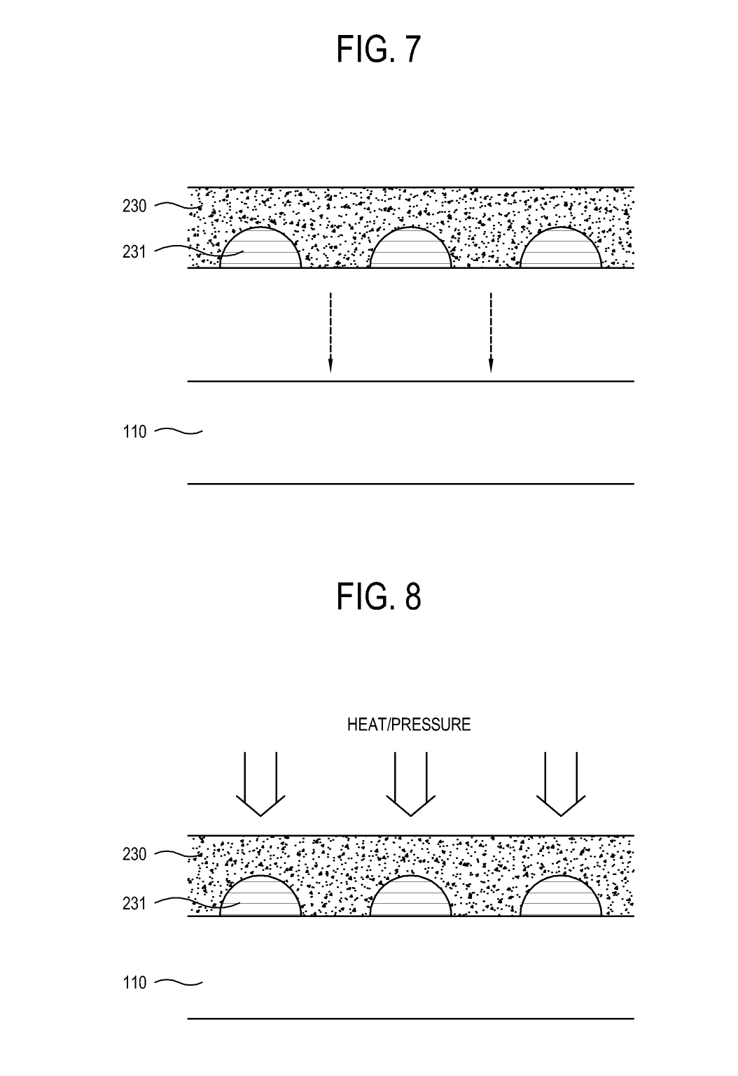

The aforementioned embodiment shows a structure and a manufacture method of the antireflection layer 170, however, exemplary embodiments are not limited thereto. Hereinafter, various methods of manufacturing the antireflection layer 170 according to exemplary embodiments will be described with reference to FIGS. 7 to 11.

FIGS. 7 and 8 schematically illustrate a process of manufacturing the antireflection layer 170 according to another exemplary embodiment.

As shown in FIG. 7, a photoresist pattern 231 is formed on a PVA film 230. A photoresist is a polymer material with a varying tolerance to a particular chemical when exposed to light. Photoresistors are classified into positive resists which become soluble to a particular chemical and negative resists which become insoluble to a particular chemical.

The PVA film 230 is stacked on the upper substrate 110 such that the photoresist pattern 231 faces the upper substrate 110.

As shown in FIG. 8, with the PVA film 230 being stacked on the upper substrate 110, both heat and pressure or one of heat and pressure is applied to the upper substrate 110, thereby forming the pattern 231 of the PVA film 230 on the upper substrate 110.

When the pattern 231 is formed on the upper substrate 110, the PVA film 230 is removed from the pattern 231 and the upper substrate 110 by being washed.

According to this process, the display panel 100 including the antireflection layer 170 may be manufactured.

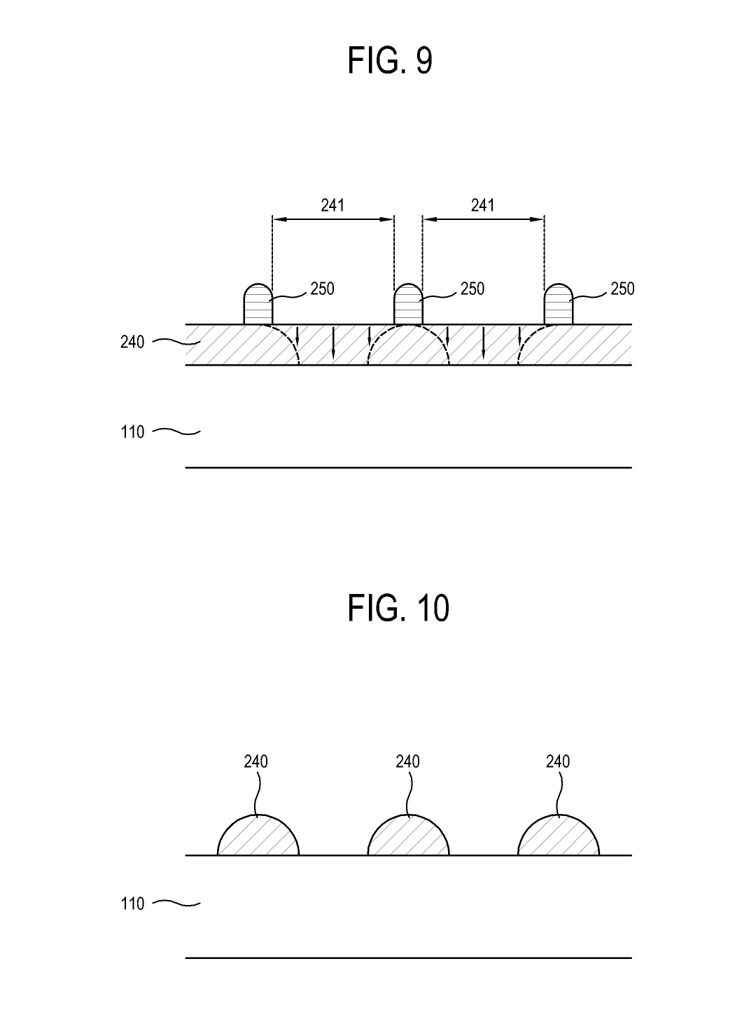

FIGS. 9 and 10 schematically illustrate a process of manufacturing the antireflection layer 170 according to a still another exemplary embodiment.

As shown in FIG. 9, a transparent silicone layer 240 is applied to the upper substrate 110, and photoresistors 250 are disposed on the silicone coating layer 240 corresponding to positions of patterns to be distributed. Various methods may be used to dispose the photoresistors 250 corresponding to the positions of the patterns to be distributed, without being particularly limited.

In this state, the silicone coating layer 240 is subjected to etching. Various etching methods including dry etching using oxygen or argon gas may be used.

An area 241 of the silicone coating layer 240 which is not covered with the photoresistors 250 is more easily corroded as compared with a covered area. When the photoresistors 250 are removed after etching is completed, silicone patterns 240 are formed on the upper substrate 110 as shown in FIG. 10.

According to this process, the display panel 100 including the antireflection layer 170 may be manufactured.

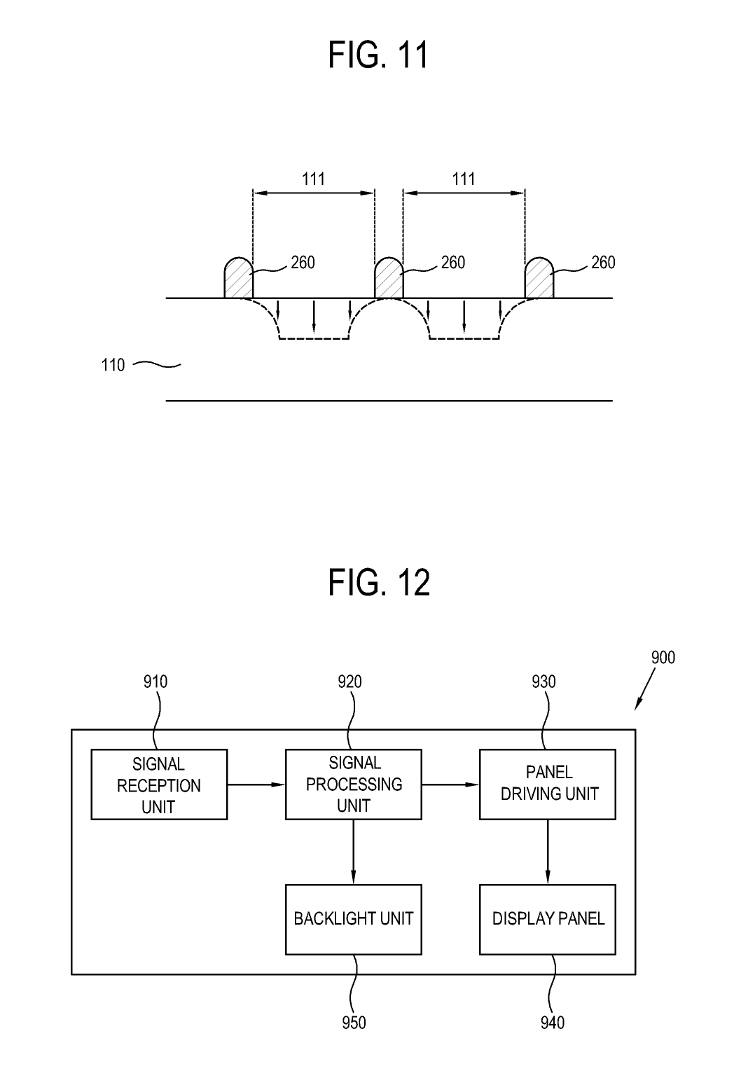

FIG. 11 schematically illustrates a process of manufacturing the antireflection layer 170 according to still another exemplary embodiment.

As shown in FIG. 11, photoresistors 260 are disposed on the upper substrate 110 corresponding to positions of patterns to be distributed. In this state, the upper substrate 110 is subjected to etching.

An area 111 of the upper substrate 110 which is not covered with the photoresistors 260 is more easily corroded as compared with a covered area. When the photoresistors 260 are removed after etching is completed, patterns are formed on the upper substrate 110.

According to this process, the display panel 100 including the antireflection layer 170 may be manufactured.

Hereinafter, a configuration of a display apparatus 900 according to a fifth exemplary embodiment will be described with reference to FIG. 12.

FIG. 12 is a block diagram illustrating a configuration of the display apparatus 900 according to an exemplary embodiment.

As shown in FIG. 12, the display apparatus 900 includes a signal reception unit 910 receiving an image signal, a signal processing unit 920 processing the image signal received by the signal reception unit 910 according to a preset image processing process, a panel driving unit 930 outputting a driving signal corresponding to the image signal processed by the signal processing unit 920, a display panel 940 displaying an image based on the image signal in accordance with the driving signal from the panel driving unit 930, and a backlight unit 950 providing light to the display panel 940 corresponding to the image signal processed by the signal processing unit 920.

In the present embodiment, the display apparatus 900 may be configured as various devices capable of displaying images, for example, a TV, a monitor, a portable media player, and a mobile phone.

The signal reception unit 910 receives an image signal or image data and transmits the image signal or image data to the signal processing unit 920. The signal reception unit 910 may be configured in various types based on standards of received image signals and/or configurations of the display apparatus 900. For example, the signal reception unit 910 may receive a radio frequency (RF) signal transmitted from a broadcasting station (not shown) wirelessly or various image signals in accordance with a composite video, a component video, a super video, Syndicat des Constructeurs d'Appareils Radiorécepteurs et Téléviseurs (SCART), high definition multimedia interface (HDMI), DisplayPort, unified display interface (UDI) or wireless HD standards via a cable. When the image signal is a broadcast signal, the signal reception 910 includes a tuner to tune to a broadcast signal of each channel. Alternatively, the signal reception unit 910 may receive an image data packet from a server (not shown) through a network.

The signal processing unit 920 performs various image processing processes on the image signal received by the signal reception unit 910. The signal processing unit 920 outputs a processed image signal to the panel driving unit 930, thereby displaying an image based on the image signal on the display panel 940.

The signal processing unit 920 may perform any kind of image processing including, without being limited to, for example, decoding corresponding to an image format of image data, de-interlacing to convert interlaced image data into a progressive form, scaling to adjust image data to a preset resolution, noise reduction to improve image quality, detail enhancement, frame refresh rate conversion, or the like.

The signal processing unit 920 may be configured as an integrated multi-functional component, such as a system on chip (SOC), or an image processing board (not shown) formed by mounting separate components which independently conduct individual processes on a printed circuit board and be embedded in the display apparatus 900.

The panel driving unit 930, the display panel 940, and the backlight unit 950 have configurations substantially the same as those in the first embodiment, and thus detailed descriptions thereof are omitted herein.

The foregoing exemplary embodiments show that the antireflection layer 170 is formed on the display panel 100 of the display apparatus 1. However, the antireflection layer may be also applied to various types of electronic devices to substantially prevent reflection of external light, for example, a camera lens, in addition to the display panel 100.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display panel of a display apparatus comprising the display panel and a backlight unit disposed under the display panel, the display panel comprising:
an upper substrate;
a lower substrate disposed to face the upper substrate in a traveling direction of light radiated from the backlight unit;
a liquid crystal layer disposed between the upper substrate and the lower substrate;
a polarizing layer disposed at least below the upper substrate and configured to transmit light polarized in a preset direction of the radiated light to the upper substrate; and
an antireflection layer formed on a light exiting surface of the upper substrate through which the radiated light exits and configured to substantially prevent reflection of external light from an external environment thereon.

2. The display panel of claim 1, wherein the antireflection layer comprises a nanoscale embossed pattern distributed on the light exiting surface of the upper substrate.

3. The display panel of claim 2, wherein the antireflection layer is formed directly on the light exiting surface of the upper substrate.

4. The display panel of claim 2, wherein the pattern has a cross section in at least one from among substantially rectangular, substantially parabolic and substantially dome shapes.

5. The display panel of claim 2, wherein the antireflection layer comprises a pattern formed of at least one from among silicone, ultraviolet (UV)-curable silicone, and a photoresist.

6. The display panel of claim 5, wherein the antireflection layer is formed by forming the pattern on a coating layer of the UV-curable silicone, the pattern being obtained by pressing a polyvinyl alcohol (PVA) film formed corresponding to the pattern against the coating layer of the UV-curable silicone formed on the upper substrate, curing the coating layer, and removing the PVA film.

7. The display panel of claim 6, wherein the coating layer is cured by UV irradiation.

8. The display panel of claim 6, wherein the PVA film is removed by washing the PVA film with water.

9. The display panel of claim 5, wherein the antireflection layer is formed by stacking a PVA film formed with the pattern of the photoresist on the upper substrate, forming the pattern on the upper substrate by using at least one from among heat and pressure, and removing the PVA film.

10. The display panel of claim 5, wherein the antireflection layer is formed by stacking the pattern of the photoresist on a coating layer of the silicone on the upper substrate, corroding the coating layer by an etching process, and removing the photoresist.

11. The display panel of claim 10, wherein the etching process comprises dry etching using at least one from among oxygen and argon gas.

12. The display panel of claim 5, wherein the antireflection layer is formed by stacking the pattern of the photoresist on the upper substrate, corroding the upper substrate by an etching process, and removing the photoresist.

13. The display panel of claim 1, wherein the polarizing layer is disposed at least one from among between the upper substrate and the liquid crystal layer, between a light exiting surface of the lower substrate and the liquid crystal layer, and under a light entering surface of the lower substrate.

14. A display apparatus comprising:
a signal reception unit configured to receive an image signal from an outside;
a signal processing unit configured to process the image signal received by the signal reception unit according to a preset image processing process; and
a display panel according to claim 1, the display panel displaying an image based on the image signal processed by the signal processing unit.
